(19) United States
(12) Patent Application Publication
(10) Pub. No.: US 2006/0004174 A1
(43) Pub. Date: Jan. 5, 2006

(54) Cleaning blade member

(75) Inventors: Masahiro Omori, Yokohama-shi (JP); Shuji Abe, Yokohama-shi (JP)

Correspondence Address: HUNTLEY & ASSOCIATES, 1105 NORTH MARKET STREET, P.O. BOX 948, WILMINGTON, DE, 19899-0948, US

(73) Assignee: Hokushin Corporation

(21) Appl. No.: 11/173,050

(22) Filed: Jul. 1, 2005

(30) Foreign Application Priority Data
Jul. 1, 2004 (JP) 2004-195521

(51) Int. Cl. C08G 18/00

(52) U.S. Cl. 528/44

(57) ABSTRACT

A cleaning blade member comprising a polyurethane formed from a polyol including at least one of a polyester polyol and a caprolactone-based diol, and a polycarbonate diol, the polyester polyol being obtained by dehydration condensation of adipic acid and a diol component, a polyisocyanate, and a crosslinking agent containing a short chain diol, which is at least one of propanediol and butanediol, and a triol having a molecular weight of 120 to 2,500, and wherein the polyurethane has a peak temperature at tan δ (1 Hz) of 0° C. or lower.

### BACKGROUND OF THE INVENTION

1. Field of the Invention

This invention relates to a cleaning blade member. More particularly, the present invention relates to a cleaning blade member for removing a toner present on a toner image bearing body, on which a toner image is formed for subsequent transfer to a transfer material, such as a photoconductor or a transfer belt in electrophotography.

2. Description of the Related Art

In the electrophotographic process, a cleaning blade for removing a toner is generally employed for repeated use of an electrophotographic photoconductor or a transfer belt. As a cleaning blade member, polyurethane is used, because polyurethane has satisfactory wear resistance, has sufficient mechanical strength without addition of a reinforcing agent, and is non-polluting. However, the physical properties of polyurethane pose the problem that they are temperature-dependent.

Among cleaning blades comprising polyurethane is a cleaning blade composed of cured polyurethane having a tensile strength at 50° C. of 12 MPa or more, a tan δ peak temperature of 15° C. or lower, and a hardness of 80° or less. Such a cleaning blade under development is aimed at effectively preventing chipping in a high temperature environment and showing satisfactory cleaning properties in a broad temperature range, without impairing cleaning properties in a low temperature environment (see Japanese Patent Application Laid-Open (kokai) No. 2001-265190).

Also available is a blade for an electrophotographic apparatus, which uses a polyurethane sheet obtained by mixing a bifunctional polyol having a number average molecular weight of 1,000 to 3,000 and a trifunctional polyol having a number average molecular weight of 92 to 980 at such a ratio as to provide an average functional group number of 2.02 to 2.20, thereby forming a mixed polyol, mixing the mixed polyol with a diisocyanate compound in an amount giving an isocyanate group content of 5 to 20% to form a prepolymer, mixing a crosslinking agent, in such an amount as to provide an OH group/NCO group equivalent ratio of 0.90 to 1.05, and a reaction accelerator, in an amount of 0.01 to 1.0 part by weight based on 100 parts by weight of the prepolymer, with the prepolymer, and reacting the mixture (see Japanese Patent Application Laid-Open (kokai) No. 9-274416).

However, these blades are not satisfactory, for example, in terms of wear resistance, and further improvements in their properties are desired.

### SUMMARY OF THE INVENTION

The present invention provides cleaning blade members having excellent wear resistance and which are usable for a long term.

Specifically, the instant invention provides a cleaning blade member comprising polyurethane which is formed by bringing together, under reaction conditions:

polyol including at least one of polyester polyol, caprolactone-based diol, and polycarbonate diol, the polyester polyol being obtained by dehydration condensation of adipic acid and diol component,

polyisocyanate, and

crosslinking agent containing at least one short chain diol selected from propanediol and butanediol, and a triol having a molecular weight of 120 to 2,500, and

wherein the polyurethane has a peak temperature at tan δ (1 Hz) of 0° C. or lower.

Preferably, the polyurethane has a tensile strength at 300% elongation at 25° C. of 250 kg/cm² or higher.

It is also preferred that the rebound resilience at 25° C. of the polyurethane is 35% or lower, and its lowest value in the range of 0 to 50° C. is at 0° C. It is further preferred that the cleaning blade member of the present invention further comprises curing retarder.

In a further preferred embodiment of the present invention, the permanent elongation of the polyurethane is 2.5% or less.

### BRIEF DESCRIPTION OF THE DRAWINGS

The present invention will be more fully understood from the detailed description given hereinbelow and the accompanying drawings which are given by way of illustration only, and thus are not limitative of the present invention, and wherein:

FIG. 1 is a graphical illustration of the results of the Examples and Comparative Examples of the present invention with respect to hardness.

FIG. 2 is a graphical illustration of the results of the Examples and Comparative Examples of the present invention with respect to rebound resilience.

### DETAILED DESCRIPTION OF THE INVENTION

The cleaning blade members of the present invention comprise a polyurethane formed by using a polyol, a polyisocyanate, and a crosslinking agent. The polyol includes at least one of a polyester polyol, which is obtained by dehydration condensation of adipic acid and a diol component; a caprolactone-based diol; and a polycarbonate diol. The crosslinking agent contains a short chain diol, which is at least one of propanediol and butanediol, and a triol having a molecular weight of 120 to 2,500. Because of these features, the cleaning blade member has a peak temperature at tan δ (1 Hz) of 0° C. or lower, can maintain rubbery nature even in a low temperature, low humidity environment, and exhibits minimal chipping. The above features also impart low rebound resilience and high strength, so that the cleaning blade has excellent wear resistance, and its long life can be ensured. If a polyurethane with low rebound resilience is formed using only a polyester polyol, which is obtained by dehydration condensation of a dibasic acid, such as adipic acid, and a diol component, or a caprolactone-based polyol, without using a polycarbonate diol, a low tan δ peak temperature or high strength cannot be achieved.

Preferably, the polyurethane is formed by using a curing retarder. This is because the polycarbonate diol quickly reacts, and the use of a curing retarder results in a long pot life, improved workability, and stable quality. In the present invention, polycarbonate diol is used, and thus a reaction accelerator cannot be used. The specific curing retarder used is not critical, but phosphates such as monobutyl phosphate, and catalysts with retardant activity, such as amine-based compounds, can be used. The amount of curing retarder incorporated is not critical. In general the curing retarder is used in an amount of 0.01 to 1 part by weight based on 100 parts by weight of the polyol.

The polyurethane preferably has a tensile strength at 300% elongation at 25° C. of 250 kg/cm² or higher. If this tensile strength is less than 250 kg/cm², the wear resistance tends to become poor and, after passage of a small number of transfer sheets, the edge of the cleaning blade may chip, or an image failure, such as a white patch, may occur. More preferably, the polyurethane has the tensile strength at 300% elongation at 25° C. of 700 kg/cm² or lower.

The rebound resilience at 25° C. of polyurethane is preferably 35% or lower and the lowest value in the range of 0 to 50° C. is preferably at 0° C. More preferably, the rebound resilience at 25° C. is higher than 3%. A low rebound resilience results in a cleaning blade with excellent wear resistance. If the rebound resilience has no minimum value in the range of 0 to 50°, namely, there is no glass transition point, rubber characteristics can be maintained even at low temperatures.

The permanent elongation of the polyurethane is preferably 2.5% or less. If the permanent elongation is greater than 2.5%, the permanent set of the edge portion of the cleaning blade during use is so great that the linear pressure drops, thereby deteriorating the cleaning performance. More preferably, the permanent elongation of the polyurethane is higher than 0%.

The cleaning blade members of the present invention are formed by using a polyol, a polyisocyanate, and a crosslinking agent containing a short chain diol and a triol having a molecular weight of 150 to 2,500. As the polyol, there are used at least one of a polyester polyol, which is obtained by dehydration condensation of adipic acid and a diol component, and a caprolactone-based diol, and a polycarbonate diol. The polycarbonate diol is obtained by reacting a diol component and a dialkyl carbonate. The diol component (base diol) as the material for the polycarbonate diol and the polyester polyol is not limited, but can include, for example, butanediol, pentanediol, hexanediol (HD), methylpentanediol, nonanediol (ND), and methyloctanediol (MOD). Two or more of these diols can be used as a mixture. The caprolactone-based diol can be a diol synthesized from ε-caprolactone and having a number average molecular weight of 1,000 to 4,000. The content of the polycarbonate diol is preferably 100 to 30% by weight in the polyol. Other polyolscan be used concomitantly in such a range as not to impair the effect of the present invention.

The proportion of the polyol incorporated is preferably 60 to 80% by weight in the polyurethane.

The polyisocyanate to be reacted with the polyol is preferably that having a molecular structure which is relatively not rigid. Examples of polyisocyanates which can be used are 4,4′-diphenylmethane diisocyanate (MDI), 2,6-toluene diisocyanate (TDI), and 1,6-hexane diisocyanate (HDI). Particularly preferred is MDI. The proportion of the polyisocyanate incorporated is preferably 30 to 80 parts by weight based on 100 parts by weight of the polyurethane. If the proportion is less than 30 parts by weight, insufficient tensile strength may result. If the proportion is more than 80 parts by weight, the permanent elongation is too great.

The α value is preferably 0.7 to 1.0. The α value is a value represented by the equation described below. If the α value is larger than 1.0, the hydroxyl groups of the crosslinking agent remain, so that the photoconductor or the like in contact with the cleaning blade is contaminated. If the α value is smaller than 0.7, the crosslinking density is too low, thus resulting in insufficient strength, or deactivation of the remaining isocyanate may take time, contaminating the photoconductor.
α value=(Number of moles of the hydroxyl groups of the crosslinking agent)/(Number of moles of the isocyanato groups remaining after the reaction between the polyol and the polyisocyanate)

The short chain diol, which is used as the crosslinking agent in the present invention, is at least one of propanediol (PD) and butanediol (BD). Typically, the propanediol is 1,3-propanediol, and the butanediol is 1,4-butanediol. Although 1,3-propanediol and 1,4-butanediol are preferred in terms of performance and cost, they are not restrictive. On the other hand, the triol, which is used as the crosslinking agent along with the short chain diol, is a triol having a molecular weight of 120 to 2,500, preferably 120 to 1,000. Examples of the triol include short chain triols such as trimethylolethane (TME) and trimethylolpropane (TMP), and caprolactone-based triols represented by the formula indicated below and having larger molecular weights than the short chain triols (i.e., triols synthesized from ε-caprolactone). The short chain diol and the triol may each be a mixture of two or more of the above-mentioned diols and triols. The proportions of these essential components of the crosslinking agent incorporated are not limited, but it is preferred that the weight ratio of these components is short chain diol:triol=50:50 to 95:5. If the content of the triol is low, the permanent elongation will be too great. If the triol content is too high, chipping will occur easily.

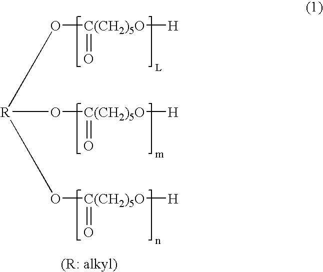

The above-described polycarbonate diol and crosslinking agent are blended with the polyisocyanate and curing retarder, followed by reacting them, to produce a polyurethane. The reaction can be performed using a general manufacturing method for polyurethane, such as the prepolymer process or the one-shot process. The prepolymer process is preferred for the present invention, since it obtains a polyurethane excellent in strength and wear resistance. However, no limitation is imposed on the manufacturing method.

The cleaning blade members of the present invention exhibit excellent wear resistance and can be used for a long term. These properties result from the use of polyurethane formed by concomitantly using at least one of a polyester polyol, which is obtained by dehydration condensation of adipic acid and a diol component, and a caprolactone-based diol, and a polycarbonate diol, and wherein the polyurethane has a peak temperature at tan δ (1 Hz) of 0° C. or lower.

The present invention will now be described in further detail based on the following examples, which in no way limit the present invention.

### EXAMPLE 1

The following components were mixed: a mixture (100 parts by weight) of equal amounts of a polycarbonate diol having a molecular weight of 2,000, which has been obtained using 1,6-hexanediol as a base diol, and a polyester diol having a molecular weight of 2,000, which has been obtained from a 1,9-nonanediol/2-methyl-1,8-octanediol mixture and adipic acid; 40 parts by weight of MDI; and a 1,3-propanediol/trimethylolethane mixture (80/20) as a crosslinking agent in such an amount as to give an α value of 0.95. Further, 0.05 part by weight of MP-4 (monobutyl phosphate) of DAIHACHI CHEMICAL INDUSTRY was added as a curing retarder. These materials were reacted to form a polyurethane, from which a test sample and a cleaning blade were produced. The content of the polycarbonate diol in the polyurethane was about 60% by weight.

### EXAMPLE 2

A test sample and a cleaning blade were produced in the same manner as in Example 1, except that a caprolactone-based triol having a molecular weight of 800 was used instead of the trimethylolethane, and the amount of MDI was changed to 50 parts by weight.

### EXAMPLE 3

A test sample and a cleaning blade were produced in the same manner as in Example 1, except that a caprolactone-based triol having a molecular weight of 2,000 was used instead of the polyester diol.

### EXAMPLE 4

A test sample and a cleaning blade were produced in the same manner as in Example 3, except that a caprolactone-based triol having a molecular weight of 800 was used instead of the trimethylolethane, and the amount of MDI was changed to 50 parts by weight.

### COMPARATIVE EXAMPLE 1

A test sample and a cleaning blade were produced in the same manner as in Example 1, except that a poly-ε-caprolactone-based diol with a molecular weight of 2,000 was used instead of the mixture of equal amounts of the polycarbonate diol and the polyester diol, a 1,4-butanediol/trimethylolpropane mixture (80/20) was used instead of the 1,3-propanediol/trimethylolethane mixture (80/20), and the amount of MDI was changed to 50 parts by weight.

### COMPARATIVE EXAMPLE 2

A test sample and a cleaning blade were produced in the same manner as in Example 1, except that a polyester diol with a molecular weight of 2,000 obtained from 1,9-nonanediol and adipic acid was used instead of the mixture of polycarbonate diol and polyester diol in equal amounts.

### COMPARATIVE EXAMPLE 3

The following components were mixed: 100 parts by weight of a polycarbonate diol having a molecular weight of 2,000 using 1,6-hexanediol as a base diol; 60 parts by weight of MDI; and a 1,3-propanediol/trimethylolethane mixture (85/15) as a crosslinking agent in such an amount as to give an α value of 0.95. Further, 0.05 part by weight of MP-4 (monobutyl phosphate) of DAIHACHI CHEMICAL INDUSTRY was added as a curing retarder. These materials were reacted to form a polyurethane, from which a test sample and a cleaning blade were produced. The content of the polycarbonate diol in the polyurethane was about 60% by weight.

### TEST EXAMPLE 1

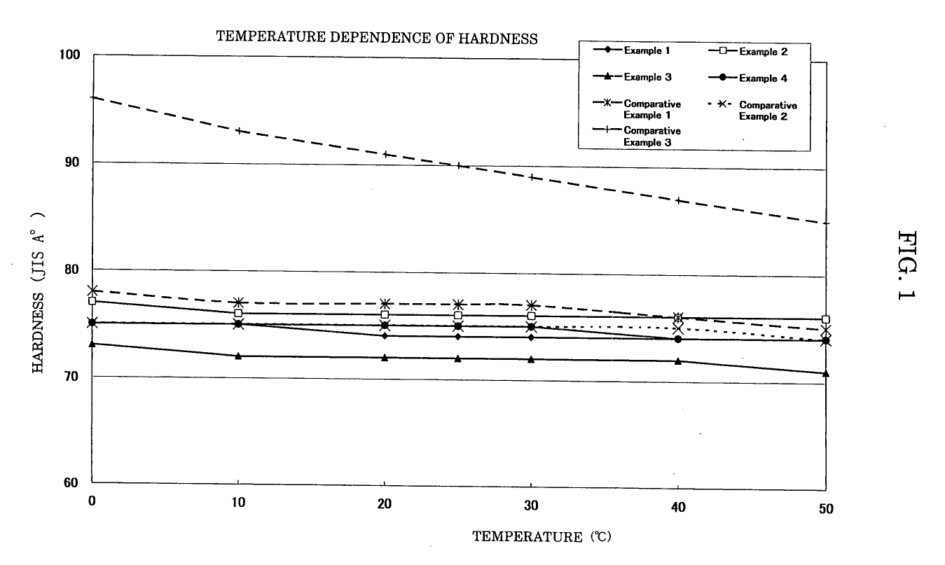

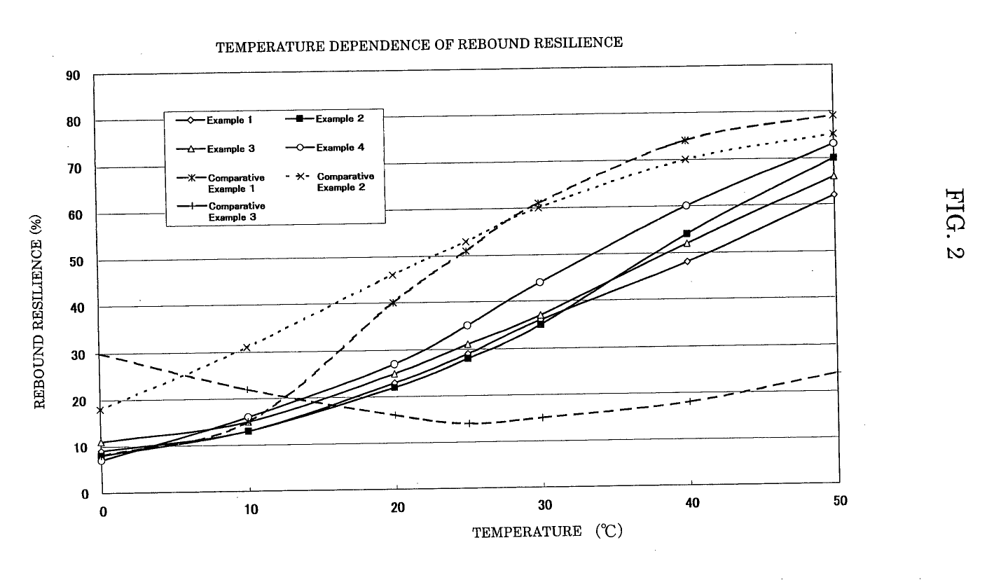

The test samples of the Examples and the Comparative Examples were each measured at 23° C. for rubber hardness (Hs) in accordance with JIS K6253, Young's modulus in accordance with JIS K6254 at 25% elongation, tensile strength at 100% elongation (100% modulus), tensile strength at 200% elongation (200% modulus), tensile strength at 300% elongation (300% modulus), tensile strength and elongation at breakage in accordance with JIS K6251, tear strength in accordance with JIS K6252, and 100% permanent elongation in accordance with JIS K6262, and also measured for rebound resilience (Rb) at 25° C. by a Lupke rebound resilience tester in accordance with JIS K6255. The tan δ was measured at 1 Hz by Seiko Instruments' thermal analysis apparatus EXSTAR 6000 DMS Viscoelasticity Spectrometer to determine the peak temperature. The hardness and the rebound resilience were also measured at 0° C. to 50° C. The results are shown in Table and FIGS. 1 and 2.

TABLE 1

| | | | | | | | Comp. | Comp. | Comp. |
|---|---|---|---|---|---|---|---|---|---|
| | | | Ex. 1 | Ex. 2 | Ex. 3 | Ex. 4 | Ex. 1 | Ex. 2 | Ex. 3 |
| Composition | Polyol | A | 1,6-HD | 1,6-HD | 1,6-HD | 1,6-HD | Caprolactone | 1,9-ND | 1,6-HD |
| | | | carbonate | carbonate | carbonate | carbonate | | adipate | carbonate |
| | | B | 1,9-ND | 1,9-ND | Caprolactone | Caprolactone | — | — | — |
| | | | MOD | MOD | | | | | |
| | | | adipate | adipate | | | | | |
| | | Proportion | 50% | 50% | 50% | 50% | 100% | 100% | 100% |
| | Isocyanate | Number of | 40 | 50 | 40 | 50 | 50 | 40 | 60 |
| | (MDI) | Parts | | | | | | | |
| | Crosslinking | Diol | PD | PD | PD | PD | BD | PD | PD |
| | agent | Triol | TME | 800 | TME | 800 | TMP | TME | TME |
| | | Ratio | 80:20 | 80:20 | 80:20 | 80:20 | 80:20 | 80:20 | 85:15 |
| | α value | | 0.95 | 0.95 | 0.95 | 0.95 | 0.95 | 0.95 | 0.95 |
| General | Hardness | JIS A° | 74 | 76 | 72 | 75 | 77 | 75 | 90 |
| properties | Rebound resilience | % | 29 | 28 | 31 | 35 | 51 | 53 | 14 |
| | (25° C.) | | | | | | | | |
| | Young's Modulus | Kg/cm² | 80 | 86 | 70 | 78 | 87 | 81 | 158 |
| | 100% Modulus | Kg/cm² | 60 | 80 | 50 | 60 | 40 | 60 | 200 |
| | 200% Modulus | Kg/cm² | 130 | 160 | 110 | 120 | 80 | 40 | 430 |
| | 300% Modulus | Kg/cm² | 330 | 380 | 280 | 280 | 150 | 230 | * |
| | Tensile strength | Kg/cm² | 490 | 560 | 510 | 470 | 340 | 400 | 540 |
| | Elongation | % | 330 | 330 | 340 | 330 | 330 | 360 | 240 |
| | Tear strength | kg/cm | 60 | 66 | 58 | 64 | 70 | 90 | 90 |
| | 100% permanent | % | 1.3 | 1.5 | 1.7 | 1.4 | 2.2 | 1.5 | 3.0 |
| | elongation | | | | | | | | |
| | tan δ peak (1 Hz) | ° C. | −2 | −7 | −1 | −6 | −6 | −12 | 30 |
| Temperature | Hardness | 0° C. | 75 | 77 | 73 | 75 | 78 | 75 | 96 |
| dependence | | 10° C. | 75 | 76 | 72 | 75 | 77 | 75 | 93 |
| | | 20° C. | 74 | 76 | 72 | 75 | 77 | 75 | 91 |
| | | 25° C. | 74 | 76 | 72 | 75 | 77 | 75 | 90 |
| | | 30° C. | 74 | 76 | 72 | 75 | 77 | 75 | 89 |
| | | 40° C. | 74 | 76 | 72 | 74 | 76 | 75 | 87 |
| | | 50° C. | 74 | 76 | 71 | 74 | 75 | 74 | 85 |
| | Rebound | 0° C. | 9 | 8 | 11 | 7 | 8 | 18 | 30 |
| | resilience | 10° C. | 13 | 13 | 15 | 16 | 15 | 31 | 22 |
| | | 20° C. | 23 | 22 | 25 | 27 | 40 | 46 | 16 |
| | | 25° C. | 29 | 28 | 31 | 35 | 51 | 53 | 14 |
| | | 30° C. | 36 | 35 | 37 | 44 | 61 | 60 | 15 |
| | | 40° C. | 48 | 54 | 52 | 60 | 74 | 70 | 18 |
| | | 50° C. | 62 | 70 | 66 | 73 | 79 | 75 | 24 |

| | | | | | | | | |
|---|---|---|---|---|---|---|---|---|
| Acceleration | Wear width (μm) | ≦5 | ≦5 | ≦5 | ≦5 | 40 | 25 | 10 |
| test | Chipping | No | No | No | No | Yes | No | Very |
| | | | | | | | | great |
| | Edge condition | Good | Good | Good | Good | ** | *** | **** |

*: Could not be measured, because breakage occurred before elongation of up to 300%.
**: Worn very greatly, and no edge was left.
***: No chipping occurred, but wear width was great.
****: very great chipping occurred, and plastic deformation of edge took place.

### TEST EXAMPLE 2

The cleaning blades in the Examples and the Comparative Examples were each mounted on an acceleration test apparatus (an apparatus in which the blade is installed for an organic photoconductor, without involvement by a toner, at a pressure and an angle of contact comparable to those in an actual machine, and which is continuously rotated at a peripheral speed of 100 to 300 rpm), and brought into contact with the photoconductor. The acceleration test apparatus was run at room temperature (about 25° C.) for a period of time corresponding to the passage of 30,000 A4-size PPC sheets in portrait orientation (i.e., about 10 hours). Then, the edge of the cleaning blade was observed under magnification by a video microscope. The results are shown in Table 1.

The cleaning blades of Examples 1 to 4 were found to be minimal in the wear width and free from chipping. On the other hand, Comparative Example 1 using the caprolactone-based polyol underwent chipping, and showed a large wear width. In Comparative Example 2 using the polyester polyol, no chipping occurred, but a great wear width was observed. In Comparative Example 3 using the short chain triol, very great chipping occurred, and the edge was plastically deformed.

While the present invention has been described by the above embodiments, it is to be understood that the invention is not limited thereby, but may be varied or modified in many other ways. Such variations or modifications are not to be regarded as a departure from the spirit and scope of the invention, and all such variations and modifications as would be obvious to one skilled in the art are intended to be included within the scope of the appended claims.

We claim:

1. A cleaning blade member comprising polyurethane which is formed by bringing together, under reaction conditions:
polyol including at least one of polyester polyol, caprolactone-based diol, and polycarbonate diol, the polyester polyol being obtained by dehydration condensation of adipic acid and diol component,
polyisocyanate, and
crosslinking agent containing at least one short chain diol selected from propanediol and butanediol, and a triol having a molecular weight of 120 to 2,500, and
wherein the polyurethane has a peak temperature at tan δ (1 Hz) of 0° C. or lower.

2. A cleaning blade member of claim 1 wherein the polyurethane exhibits a tensile strength at 300% elongation at 25° C. of at least 250 kg/cm².

3. A cleaning blade member of claim 1 wherein the polyurethane exhibits a rebound resilience at 25° C. of 35% or lower, and a lowest value thereof in the range of 0 to 50° C. is at 0° C.

4. A cleaning blade member of claim 1 which further comprises curing retarder.

5. A cleaning blade member of claim 1 wherein the polyurethane exhibits a permanent elongation of 2.5% or less.
